(19) United States
(12) Patent Application Publication
(10) Pub. No.: US 2020/0028430 A1
(43) Pub. Date: Jan. 23, 2020

(54) POWER CONVERTER AND ELECTRIC MOTOR SYSTEM

(71) Applicant: TOYOTA JIDOSHA KABUSHIKI KAISHA, Toyota-shi (JP)

(72) Inventors: Ken TOSHIYUKI, Nisshin-shi (JP); Koichi SAKATA, Okazaki-shi (JP)

(73) Assignee: TOYOTA JIDOSHA KABUSHIKI KAISHA, Toyota-shi (JP)

(21) Appl. No.: 16/458,346

(22) Filed: Jul. 1, 2019

(30) Foreign Application Priority Data
Jul. 19, 2018 (JP) 2018-135596

(51) Int. Cl. H02M 1/08; H02P 27/06; H02M 7/537; H02K 11/33

(52) U.S. Cl. CPC H02M 1/08; H02P 27/06; H02M 2001/0009; H02K 11/33; H02M 7/537

(57) ABSTRACT

A power converter may include first and second switching elements connected in parallel each other, first and second diodes connected to positive terminals of the switching elements, first and second current sensors, a reactor, and a controller that alternately turns on the first and second switching elements. One end of the reactor may be connected to first and second intermediate points. The first and second current sensors may detect currents flowing between the reactor and the first intermediate point and between the reactor and the second intermediate point, respectively. The first and second current sensors may respectively include first and second magnetism collecting ring cores, into which a first conductor between the reactor and the first intermediate point and a second conductor between the reactor and the second intermediate point are respectively inserted.

### CROSS-REFERENCE

This application claims priority to Japanese Patent Application No. 2018-135596, filed on Jul. 19, 2018, the entire contents of which are incorporated herein by reference.

### TECHNICAL FIELD

The disclosure herein relates to a power converter and an electric motor system including the power converter.

### BACKGROUND

Japanese Patent Application Publication No. 2001-186768 describes a power converter including switching elements connected in parallel. This power converter includes two switching elements, two diodes, a main reactor, and two sub reactors. A first switching element and a first diode are connected in series, and a second switching element and a second diode are also connected in series. These two series circuits are connected in parallel. The main reactor is connected to each of intermediate points of these series circuits. A first sub reactor is connected between the main reactor and one of the intermediate points (an intermediate point on a first switching element side) and a second sub reactor is connected between the main reactor and the other of the intermediate points (an intermediate point on a second switching element side). A controller of the power converter turns on and off the two switching elements alternately. When the switching elements are switched from off to on, a switching loss is suppressed by induced voltages of the two sub reactors. Further, Japanese Patent Application Publication No. 2007-288876 also describes a technique that suppresses a switching loss by using a plurality of reactors.

### SUMMARY

In general, a power converter also includes a current sensor for measuring current that flows in a main reactor. The current sensor of one type includes a magnetism collecting ring core that surrounds a conductor. The current sensor uses the magnetism collecting ring core to collect magnetic flux generated by current flowing in the conductor. The current sensor measures the magnetic flux flowing through the magnetism collecting ring core and obtains the current flowing in the conductor from the measured magnetic flux. Meanwhile, a sub reactor is provided for a purpose of suppressing a switching loss, thus it only needs to have a small inductance. The inventors of the present application have discovered that a characteristic (magnitude of inductance) required for the sub reactor and a characteristic of the magnetism collecting ring core of the current sensor are similar and the magnetism collecting ring core and the conductor inserted therein can serve as the sub reactor. Based on this discovery, the disclosure herein provides a technique that realizes a power converter capable of reducing a switching loss with a reduced number of components.

A power converter disclosed herein may comprise a first switching element, a second switching element, a first diode, a second diode, a first current sensor, a second current sensor, a reactor, and a controller. The first and second switching elements may be connected in parallel. The controller may be configured to alternately turn on the first switching element and the second switching element. The first diode may be connected to a positive terminal of the first switching element, and the second diode may be connected to a positive terminal of the second switching element. In other words, a series circuit of the first switching element and the first diode is connected in parallel with a series circuit of the second switching element and the second diode. In a case where the switching elements are n-type transistors, the positive terminals of the switching elements correspond to collectors or drains.

An intermediate point of the series circuit of the first switching element and the first diode is termed a first intermediate point, and an intermediate point of the series circuit of the second switching element and the second diode is termed a second intermediate point. One end of the reactor may be connected to the first intermediate point and the second intermediate point. The first current sensor may be configured to detect current that flows between the reactor and the first intermediate point. The second current sensor may be configured to detect current that flows between the reactor and the second intermediate point. The first current sensor may comprise a first magnetism collecting ring core into which a first conductor between the reactor and the first intermediate point is inserted. The second current sensor may comprise a second magnetism collecting ring core into which a second conductor between the reactor and the second intermediate point is inserted. Each of the first magnetism collecting ring core and the second magnetism collecting ring core functions as a sub reactor. Current that flows in the reactor (the main reactor) can be obtained by adding measured values of the first current sensor and the second current sensor. Conventional power converters required three electric components (two sub reactors and one current sensor), however, the power converter disclosed herein can realize the same function by two electric components (two current sensors). That is, the power converter disclosed herein can reduce a switching loss with a reduced number of components as compared to the conventional ones. A mechanism for suppressing the switching loss will be described in embodiments.

The technique disclosed herein can be adapted to a voltage converter provided with a reactor, and may be adapted to an electric motor system including an inverter and an AC motor. In a case of the electric motor system, a winding wire of an electric motor corresponds to the main reactor. The parallel circuit of the two switching elements in the above power converter corresponds to lower-arm switching elements of the inverter. The two diodes correspond to freewheel diodes connected in inverse parallel to upper-arm switching elements. A total value of the measured values of the two current sensors corresponds to current that flows in the electric motor (main reactor). Such an electric motor system can control the current that flows in the electric motor by using the total value of the two current sensors.

Details and further improvements of the technique disclosed herein will be described in the Detailed Description as below.

### BRIEF DESCRIPTION OF DRAWINGS

FIG. 1 shows a circuit of a power converter according to a first embodiment.

FIG. 2 shows a perspective view of a power module and a reactor.

FIG. 3 shows a perspective view of a current sensor.

FIG. 4 shows a time chart for current that flows in the reactor and gate voltages of switching elements.

FIG. 5 shows how current flows at each of time points in the time chart of FIG. 4.

FIG. 6 shows a circuit of a power converter according to a second embodiment.

FIG. 7 shows a time chart for current that flows in a reactor and gate voltages of switching elements (second embodiment).

FIG. 8 shows a block diagram of a third embodiment (an electric motor system).

FIG. 9 shows a block diagram of a switching circuit.

FIG. 10 shows a perspective view of a current sensor according to a variant.

FIG. 11 shows an arrangement of current sensors for cancelling errors.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure herein. Furthermore, each of the additional features and teachings disclosed below may be utilized separately or in conjunction with other features and teachings to provide improved power converters and electric motor systems, as well as methods for using and manufacturing the same.

Moreover, combinations of features and steps disclosed in the following detailed description may not be necessary to practice the disclosure herein in the broadest sense, and are instead taught merely to particularly describe representative examples of the disclosure herein. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

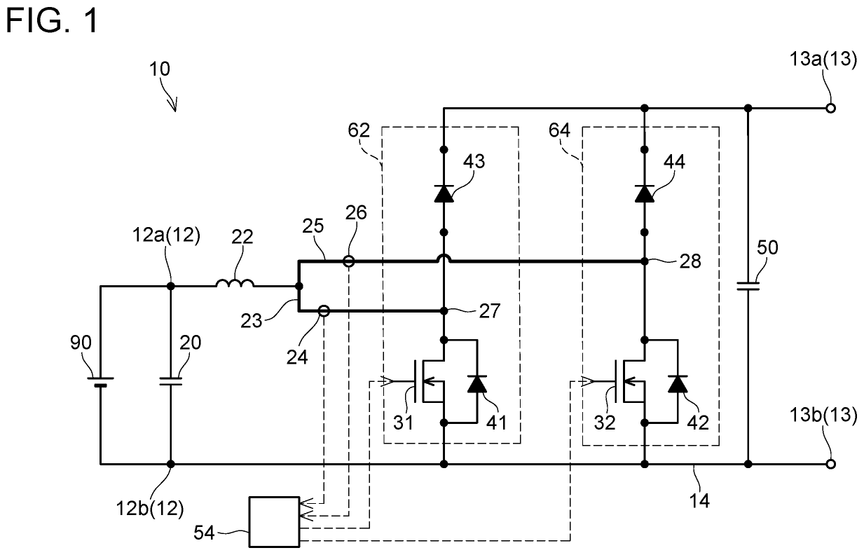

A power converter according to a first embodiment will be described with reference to the drawings. The power converter according to the first embodiment is a boost converter 10. FIG. 1 shows a circuit diagram of the boost converter 10. A battery 90 is connected to a low voltage terminal 12 of the boost converter 10. Although not shown, a load such as an inverter is connected to a high voltage terminal 13. The boost converter 10 is configured to boost a voltage applied to the low voltage terminal 12 and output the boosted voltage from the high voltage terminal 13. Positive and negative terminals of the low voltage terminal 12 will respectively be termed a low voltage positive terminal 12a and a low voltage negative terminal 12b, and positive and negative terminals of the high voltage terminal 13 will respectively be termed a high voltage positive terminal 13a and a high voltage negative terminal 13b. The low voltage negative terminal 12b and the high voltage negative terminal 13b are connected directly by a common negative terminal line 14.

The boost converter 10 includes a first switching element 31, a second switching element 32, a first lower diode 41, a second lower diode 42, a first upper diode 43, a second upper diode 44, a reactor 22, a filtering capacitor 20, and a smoothing capacitor 50.

A negative terminal of the first switching element 31 is connected to the common negative terminal line 14. A positive terminal of the first switching element 31 is connected to an anode of the first upper diode 43. A cathode of the first upper diode 43 is connected to the high voltage positive terminal 13a. An intermediate point in a series circuit of the first switching element 31 and the first upper diode 43 will be termed a first intermediate point 27. The first lower diode 41 is connected in inverse parallel to the first switching element 31. A broken line surrounding the first switching element 31, the first lower diode 41, and the first upper diode 43 shows a power module 62. The power module 62 will be described later.

A negative terminal of the second switching element 32 is connected to the common negative terminal line 14. A positive terminal of the second switching element 32 is connected to an anode of the second upper diode 44. A cathode of the second upper diode 44 is connected to the high voltage positive terminal 13a. An intermediate point in a series circuit of the second switching element 32 and the second upper diode 44 will be termed a second intermediate point 28. The second lower diode 42 is connected in inverse parallel to the second switching element 32. A broken line surrounding the second switching element 32, the second lower diode 42, and the second upper diode 44 shows a power module 64. The power module 64 will be described later.

The first and second switching elements 31, 32 are both n-type Metal Oxide Semiconductor Field Effect Transistors (MOSFETs). The first and second switching elements 31, 32 may be switching elements of another type such as Insulated Gate Bipolar Transistors (IGBTs). In a case where they are n-type MOSFETs, the positive terminals of the switching elements are called drains. In a case where they are n-type IGBTs, the positive terminals of the switching elements are called collectors. In the case where they are the MOSFETs, current can be flowed from the negative terminals to the positive terminals, however, in the disclosure herein, the collectors or the drains of the n-type switching elements are termed the positive terminals for the sake of convenience.

One end of the reactor 22 is connected to each of the first intermediate point 27 and the second intermediate point 28, and another end of the reactor 22 is connected to the low voltage positive terminal 12a.

The filtering capacitor 20 is connected between the low voltage positive terminal 12a and the low voltage negative terminal 12b, and the smoothing capacitor 50 is connected between the high voltage positive terminal 13a and the high voltage negative terminal 13b.

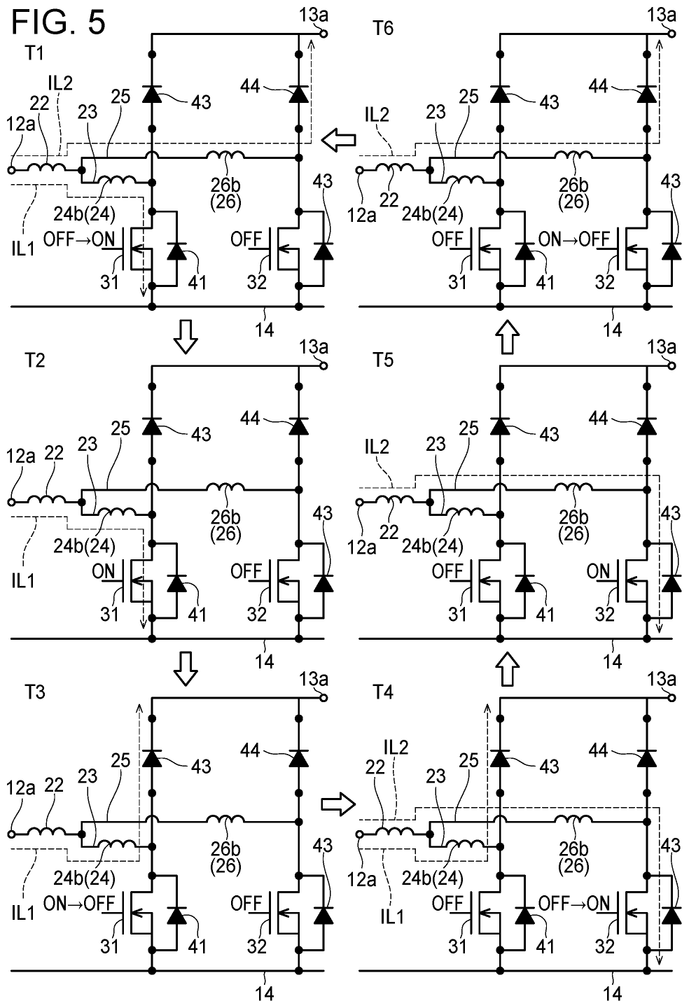

As shown in FIG. 1, the first switching element 31 and the second switching element 32 are connected in parallel. The boost converter 10 shown in FIG. 1 distributes power to the two switching elements 31, 32 connected in parallel, thus it can boost a large power. A boost operation in the circuit shown in FIG. 1 will be described later with reference to FIG. 5.

A first current sensor 24 is arranged on a first conductor 23 that connects the reactor 22 and the first intermediate point 27, and a second current sensor 26 is arranged on a second conductor 25 that connects the reactor 22 and the second intermediate point 28. A portion indicated by a bold line in the circuit diagram of FIG. 1 corresponds to the first conductor 23 and the second conductor 25. The first current sensor 24 is configured to detect current that flows between the reactor 22 and the first intermediate point 27, and the second current sensor 26 is configured to detect current that flows between the reactor 22 and the second intermediate point 28. A total of outputs of the first current sensor 24 and the second current sensor 26 corresponds to current that flows in the reactor 22.

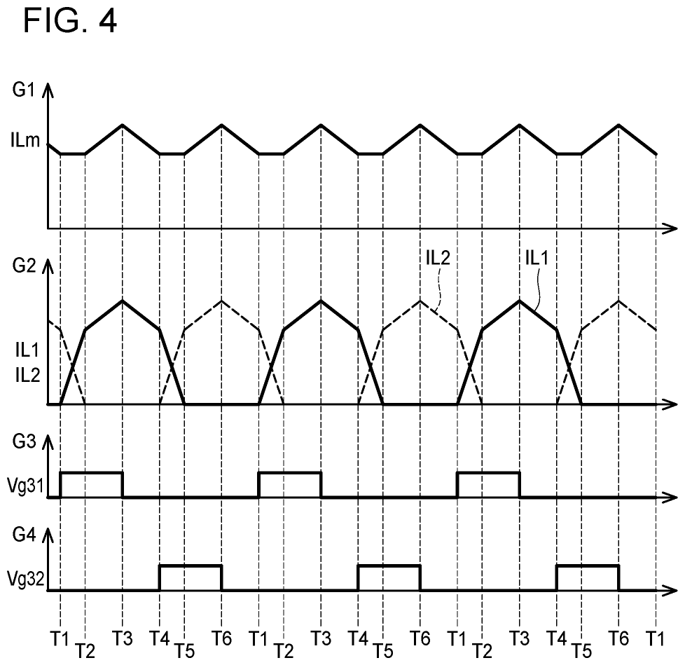

Measured values of the first current sensor 24 and the second current sensor 26 are sent to a controller 54. The controller 54 is configured to calculate the current that flows in, the reactor 22 from the measured values of the two current sensors. Further, the controller 54 is configured to receive a target output of the boost converter 10 from a host controller that is not shown. The controller 54 is configured to control the first and second switching elements 31, 32 by using the measured values of the first and second current sensors 24, 26 such that an output of the boost converter 10 follows the target output. The controller 54 is configured to alternately turn on and off the first switching element 31 and the second switching element 32. Operations of the first and second switching elements 31, 32 will be described later with reference to FIGS. 4 and 5.

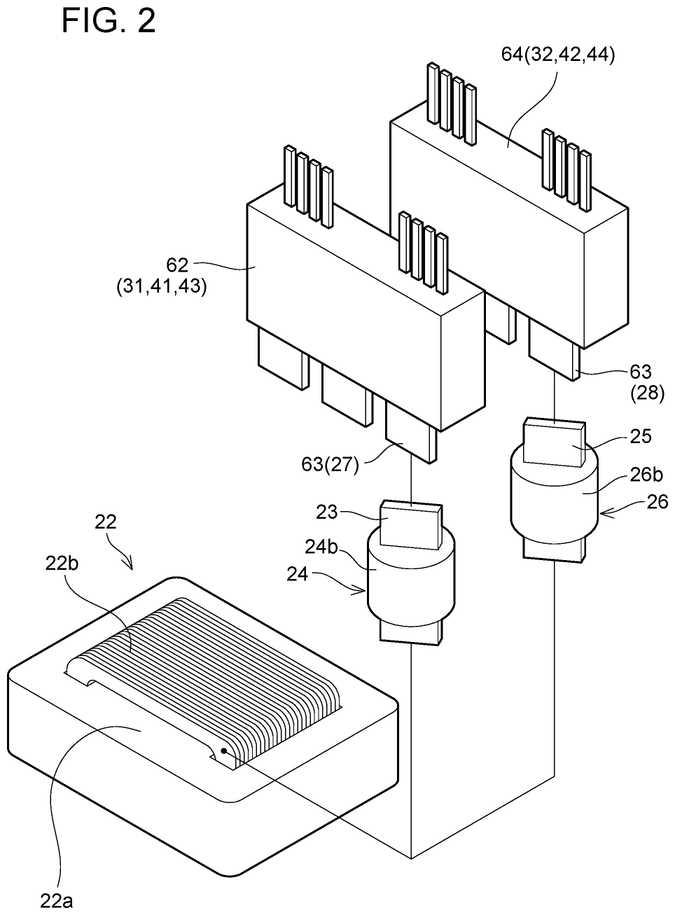

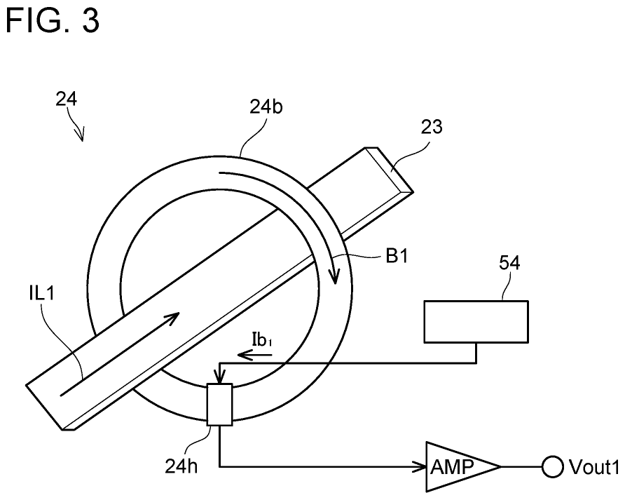

Hardware included in part of components of the boost converter 10 will be described with reference to FIGS. 2 and 3. FIG. 2 is a perspective view of the power modules 62, 64 and the reactor 22. The first switching element 31, the first lower diode 41, and the first upper diode 43 of FIG. 1 are housed in the power module 62. The power module 62 is constituted of a resin package and terminals. A semiconductor chip that implements the first switching element 31, the first lower diode 41, and the first upper diode 43 is housed in the package. In the package, the first switching element 31 and the first lower diode 41 are connected in inverse parallel and the first switching element 31 and the first upper diode 43 are connected in series. A power terminal 63 extending from the package is electrically connected to the intermediate point in the series circuit of the first switching element 31 and the first upper diode 43 inside the package. That is, the power terminal 63 of the power module 62 corresponds to the first intermediate point 27 of FIG. 1.

The second switching element 32, the second lower diode 42, and the second upper diode 44 of FIG. 1 are housed in a package of the power module 64. A structure of the power module 64 is the same as that of the power module 62. A power terminal 63 extending from the package of the power module 64 is electrically connected to the intermediate point in the series circuit of the second switching element 32 and the second upper diode 44 inside the package. That is, the power terminal 63 of the power module 64 corresponds to the second intermediate point 28 of FIG. 1.

The reactor 22 has a structure in which a winding wire 22b is wound plural times on a core 22a constituted of a material with high-magnetic permeability. One end of the reactor 22, that is, one end of the winding wire 22b and the power terminal 63 of the power module 62 are connected by the first conductor 23. The one end of the winding wire 22b and the power terminal 63 of the power module 64 are connected by the second conductor 25. The first current sensor 24 is provided on the first conductor 23, and the second current sensor 26 is provided on the second conductor 25. The first conductor 23 and the second conductor 25 are narrow metal plates called bus bars.

FIG. 3 shows a perspective view of the first current sensor 24. The first current sensor 24 includes a first magnetism collecting ring core 24b through which the first conductor 23 is inserted and a Hall element 24h. The first magnetism collecting ring core 24b is constituted of a material with high-magnetic permeability. The first magnetism collecting ring core 24b has one notch provided therein and the Hall element 24h is arranged in this notch. When current IL1 flows in the first conductor 23, magnetic flux B1 is generated in the first magnetism collecting ring core 24b. The magnetic flux B1 is collected by the first magnetism collecting ring core 24b. Meanwhile, constant current (bias current Ib₁) is supplied to the Hall element 24h from the controller 54. Lorentz force generated by the magnetic flux B1 and the bias current Ib₁ causes electrons in the Hall element 24h to migrate, and a voltage is generated by this migration. A voltage Vₒᵤₜ₁ is obtained by amplifying that voltage, and the first current sensor 24 can measure the current IL1 that flows in the first conductor 23 based on this voltage Vₒᵤₜ₁. The first current sensor 24 sends the measured current IL1 to the controller 54. The first current sensor 24 may output the voltage Vₒᵤₜ₁, and the controller 54 may convert the voltage Vₒᵤₜ₁ to the current ILL

A structure of the second current sensor 26 is the same as that of the first current sensor 24, and the second current sensor 26 includes a second magnetism collecting ring core 26b through which the second conductor 25 is inserted and a Hall element. The second current sensor 26 measures current IL2 that flows in the second conductor 25. The measured current IL2 is also sent to the controller 54. The total of the measured values of the first current sensor 24 and the second current sensor 26 corresponds to the current that flows in the reactor 22.

As described above, the controller 54 obtains the current that flows in the reactor 22 from the measured values of the first current sensor 24 and the second current sensor 26, and controls the first and second switching elements 31, 32 based on the current value of the reactor 22.

As shown in FIG. 3, the first current sensor 24 includes the first magnetism collecting ring core 24b through which the first conductor 23 is inserted. The magnetic flux B1 is generated in the first magnetism collecting ring core 24b due to the current that flows in the first conductor 23. The magnetic flux B1 is generated by an inductance of the first magnetism collecting ring core 24b. That is, the first magnetism collecting ring core 24b through which the first conductor 23 is inserted functions as a reactor. The second magnetism collecting ring core 26b provided in the second current sensor 26 also functions as a reactor.

The first magnetism collecting ring core 24b of the first current sensor 24 and the second magnetism collecting ring core 26b of the second current sensor 26 both function as reactors. According to this function, a state where the current in the first conductor 23 is zero can be realized immediately before the first switching element 31 is switched from off to on in the circuit configuration of FIG. 1. When current in a conductor which is on an upstream side to a switching element is zero upon when the switching element is switched from off to on, a switching loss can be suppressed.

Reactance of each of the magnetism collecting ring cores 24b, 26b is about 1 [μH]. On the other hand, reactance required in the reactor 22 is 50 to 100 [μH]. This difference in the reactances is convenient in suppressing the switching loss without affecting the function of the reactor 22.

The mechanism by which the switching loss is suppressed will be described with reference to FIGS. 4 and 5. FIGS. 4 and 5 are also diagrams for explaining operations of the boost converter 10. FIG. 4 is a time chart for current that flows in the reactor and gate voltages of the switching elements 31, 32. FIG. 5 is a diagram that indicates how current flows at each of time points in the time chart of FIG. 4. A graph G1 of FIG. 4 indicates current ILm that flows in the reactor 22. A graph G2 indicates the current IL1 that flows in the first conductor 23 and the current IL2 that flows in the second conductor 25. A solid line indicates the current IL1 that flows in the first conductor 23 and a broken line indicates the current IL2 that flows in the second conductor 25. A graph G3 indicates a gate voltage Vg31 of the first switching element 31, and a graph G4 indicates a gate voltage Vg32 of the second switching element 32. A period during which the gate voltage is at a HIGH level corresponds to a period during which the switching element is on, and a period during which the gate voltage is at a LOW level corresponds to a period during which the switching element is off. A rise in the gate voltage Vg31 corresponds to a timing when the first switching element 31 is switched from off to on. A fall in the gate voltage Vg31 corresponds to a timing when the first switching element 31 is switched from on to off. This same relationships are applied between the gate voltage Vg32 and the second switching element 32. The gate voltages Vg31, Vg32 are controlled by the controller 54.

As shown in FIG. 4, the first switching element 31 is switched from off to on at time T1 and the first switching element 31 is switched from on to off at time T3. The second switching element 32 is maintained to be off during a period from time T1 to time T4. The second switching element 32 is switched from off to on at time T4 and is switched from on to off at time T6. The first switching element 31 is maintained to be off during a period from time T3 to time T6. In other words, the first switching element 31 and the second switching element 32 are turned on and off alternately. In other words, the controller 54 maintains the second switching element 32 to be off while the first switching element 31 is on, and maintains the first switching element 31 to be off while the second switching element 32 is on. The switching elements 31, 32 repeat their operations from time T1 to time T6.

FIG. 5 shows how current flows at each of time T1 to time T6. In FIG. 5, the circuit configuration of the boost converter 10 is simplified as compared to that of FIG. 1. Further, in FIG. 5, each of the first magnetism collecting ring core 24b of the first current sensor 24 and the second magnetism collecting ring core 26b of the second current sensor 26 is indicated by the symbol for coil. This is because these magnetism collecting ring cores function as reactors.

Operations at the respective times will be described. At time T1, the first switching element 31 is switched from off to on. The second switching element 32 is maintained to be off. Although details will be described later, no current is flowing in the first conductor 23 immediately before the first switching element 31 is switched to on. That is, a zero-current switching (ZCS) is realized, by which the switching loss is suppressed. A mechanism that realizes the zero-current switching will be described later.

When the first switching element 31 is switched to on, the current IL1 starts to flow from the low voltage positive terminal 12a to the common negative terminal line 14 through the reactor 22, the first conductor 23, and the first switching element 31. Further, immediately before time T1, the current IL2 was flowing from the low voltage positive terminal 12a to the high voltage positive terminal 13a through the reactor 22, the second conductor 25, and the second upper diode 44. A state immediately before time T1, that is, a state at time T6, will be described later.

Since the current that was flowing in the second conductor 25 shifts to the first conductor 23, the current IL2 decreases rapidly and the current IL1 increases rapidly in a period from time T1 to time T2. During this period, the current ILm that flows in the reactor 22 hardly changes. Change rates of the currents IL1, IL2 are dependent on reactances of the magnetism collecting ring cores 24b, 26b.

The current IL2 that flows in the second conductor 25 becomes zero at time T2. That is, at time T2, the current that flows in the second upper diode 44 becomes zero and the diode 44 is switched to off. Upon when the diode 44 is switched to off, reverse recovery current flows from the cathode to the anode thereof. This reverse recovery current is a cause of the switching loss and noise. However, the first conductor 23 and the second conductor 25 are provided with the first magnetism collecting ring core 24b and the second magnetism collecting ring core 26b that function as sub reactors. A maximum current change rate of the second upper diode 44 is reduced by the reactances of the first magnetism collecting ring core 24b and the second magnetism collecting ring core 26b, by which the reverse recovery current is suppressed. That is, the switching loss and the noise generated upon when the second upper diode 44 is turned off are suppressed by the first magnetism collecting ring core 24b and the second magnetism collecting ring core 26b.

From time T2 and then on, an induced voltage of the reactor 22 and an induced voltage of the first magnetism collecting ring core 24b (induced voltages that act in a direction blocking the current IL1) is weakened, and thus the current that flows in from the low voltage positive terminal 12a increases. As a result, the current ILm that flows in the reactor 22 and the current IL1 that flows in the first conductor 23 both increases.

At time T3, the first switching element 31 is switched from on to off. When the first switching element 31 is switched to off, the reactor 22 and the first magnetism collecting ring core 24b generate induced voltages in a direction allowing the current IL1 to keep flowing. The induced voltages cause the current IL1 to flow from the low voltage positive terminal 12a through the reactor 22, the first conductor 23, and the first upper diode 43. The current IL1 that flows through the first upper diode 43 charges the smoothing capacitor 50 (see FIG. 1). As the smoothing capacitor 50 is charged, a voltage at the high voltage positive terminal 13a rises. That is, the voltage applied to the low voltage terminal 12 is boosted and outputted from the high voltage terminal 13. From time T3 and then on, the induced voltages of the reactor 22 and the first magnetism collecting ring core 24b (induced voltages that act in the direction allowing the current IL1 to flow) decrease, so the current IL1 decreases gradually. Due to this, the current ILm that flows in the reactor 22 also decreases gradually.

From time T3 and then on, when the current flows in the first upper diode 43, a cathode voltage of the first upper diode 43 becomes lower than an anode voltage thereof due to a forward voltage drop. As a result, current may flow from the reactor 22 through the second conductor 25 and the second upper diode 44. However, the reactance of the second magnetism collecting ring core 26b arranged at the second conductor 25 suppresses the current from the reactor 22 toward the second upper diode 44. Due to this reactance effect of the second magnetism collecting ring core 26b, no current flows in the second conductor 25 immediately before time T4 (next to time T3).

At time T4, the second switching element 32 is switched from off to on. As described above, no current flows in the second conductor 25 immediately before time T4. Thus, the zero-current switching is realized upon when the second switching element 32 is switched to on. Since the second switching element 32 is switched to on, the current IL2 flows from the low voltage positive terminal 12a to the common negative terminal line 14 through the reactor 22, the second conductor 25, and the second switching element 32. The current IL1 was flowing through the first conductor 23 and the first upper diode 43 immediately before time T4. When the second switching element 32 is switched to on, the current that was flowing in the first conductor 23 shifts to the second conductor 25. As a result, the current IL1 decreases rapidly, and at the same time, the current IL2 increases rapidly. During this time, the current ILm that flows in the reactor 22 hardly changes.

At time T5, the current IL1 that flows in the first conductor 23 becomes zero. That is, at time T5, the current flowing in the first upper diode 43 becomes zero and the diode 43 is switched to off. At this time, reverse recovery current flows from the cathode to the anode thereof. As described above, the reverse recovery current may cause the switching loss and noise. However, the first conductor 23 and the second conductor 25 are provided with the first magnetism collecting ring core 24b and the second magnetism collecting ring core 26b that function as sub reactors. A maximum current change rate of the first upper diode 43 is suppressed by the reactances of the first magnetism collecting ring core 24b and the second magnetism collecting ring core 26b, by which the reverse recovery current is suppressed. As a result, the switching loss and the noise can be reduced.

From time T5 and then on, the induced voltage of the reactor 22 and the induced voltage of the second magnetism collecting ring core 26b (induced voltages that act in a direction blocking the current IL2) is weakened, and thus the current that flows in from the low voltage positive terminal 12a increases. As a result, the current ILm that flows in the reactor 22 and the current IL2 that flows in the second conductor 25 both increase.

At time T6, the second switching element 32 is switched from on to off. When the second switching element 32 is switched to off, the reactor 22 and the second magnetism collecting ring core 26b generate induced voltages in a direction allowing the current IL2 to keep flowing, and thus the current IL2 flows from the low voltage positive terminal 12a through the reactor 22, the second conductor 25, and the second upper diode 44. The current IL2 that flows through the second upper diode 44 charges the smoothing capacitor 50 (see FIG. 1). As the smoothing capacitor is charged, a voltage at the high voltage positive terminal 13a rises. That is, the voltage applied to the low voltage terminal 12 is boosted and outputted from the high voltage terminal 13. From time T6 and then on, the induced voltages of the reactor 22 and the second magnetism collecting ring core 26b (induced voltages that act in the direction allowing the current IL2 to flow) decrease, so the current IL2 decreases gradually. Due to this, the current ILm that flows in the reactor 22 also decreases gradually.

From time T6 and then on, when the current flows in the second upper diode 44, a cathode voltage of the second upper diode 44 becomes lower than an anode voltage thereof due to a forward voltage drop. As a result, current may flow from the reactor 22 toward the first upper diode 43. However, the reactance of the first magnetism collecting ring core 24b arranged at the first conductor 23 suppresses the current from the reactor 22 toward the first upper diode 43. Due to this reactance effect of the first magnetism collecting ring core 24b, no current flows in the first conductor 23 immediately before time T1 (time T1 in a second cycle).

After this, the operations from time T1 to time T6 are repeated. As above, the controller 54 turns on and off the first switching element 31 and the second switching element 32 alternately. The boost converter 10 including the circuit of FIG. 1 can reduce the switching loss by being provided with the current sensors including the magnetism collecting ring cores respectively in the first conductor 23 and the second conductor 25. The switching loss reduction effect, which was conventionally achieved by two sub reactors and one current sensor, is achieved by the two current sensors in the boost converter 10 according to the first embodiment. The boost converter 10 according to the first embodiment can reduce the switching loss with a reduced number of components.

### Second Embodiment

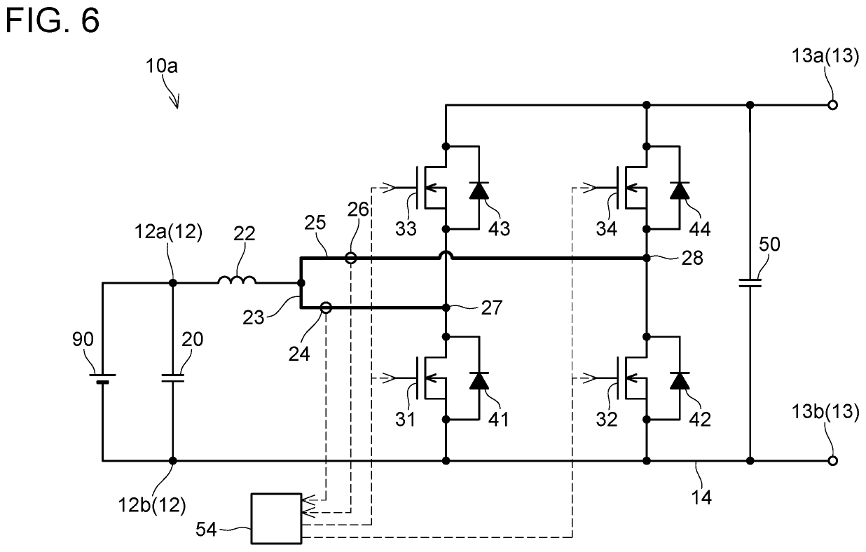

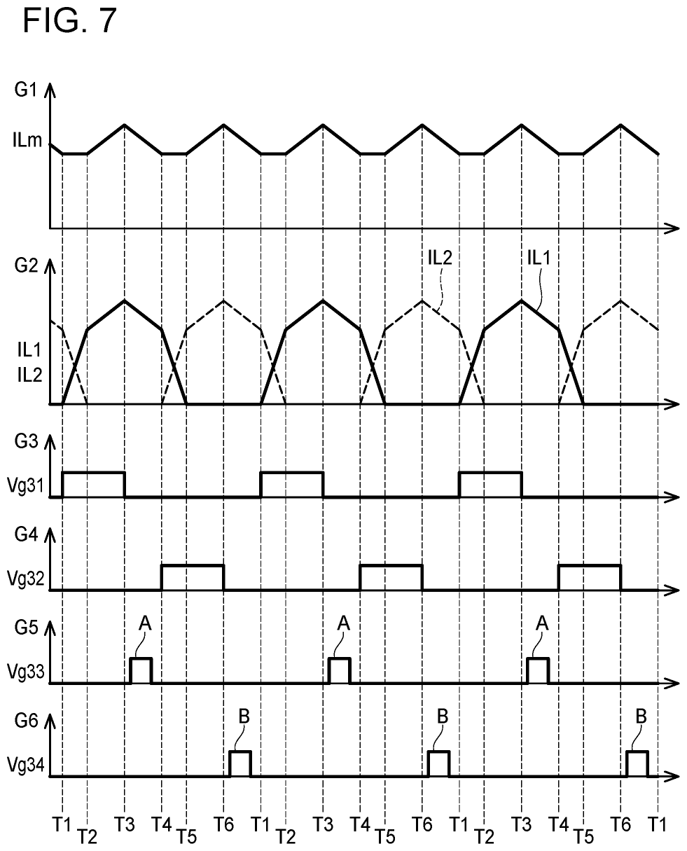

Next, a power converter according to a second embodiment will be described with reference to FIGS. 6 and 7. The power converter according to the second embodiment is a bidirectional DC-DC converter 10a. Hereinbelow, the bidirectional DC-DC converter 10a will simply be termed the bidirectional converter 10a for simplicity of explanation.

FIG. 6 shows a circuit diagram of the bidirectional converter 10a. The bidirectional converter 10a has a configuration in which a third switching element 33 and the fourth switching element 34 are added to the circuit of FIG. 1. The third switching element 33 is connected in inverse parallel to the first upper diode 43. The fourth switching element 34 is connected in inverse parallel to the second upper diode 44. The third and fourth switching elements 33, 34 are n-type MOSFETs, and are configured to allow current to flow from their positive terminals (drains) to negative terminals (sources) and are also configured to allow current to flow from the negative terminals (sources) to the positive terminals (drains).

A boosting operation of the bidirectional converter 10a is the same as that of the boost converter 10 of FIG. 1. On the other hand, when a voltage is applied to the high voltage terminal 13, a step-down operation is realized by the third and fourth switching elements 33, 34 being turned on and off. The circuit configuration of FIG. 6 and operations thereof are well known, except for the current sensors 24, 26 that function as reactors, so detailed descriptions therefor will be omitted.

When the bidirectional converter 10a of FIG. 6 performs the boosting operation, the same advantage as that of the boost converter 10 of the first embodiment, that is, the switching loss reduction effect can be obtained.

The bidirectional converter 10a can reduce loads on the first upper diode 43 and the second upper diode 44 by utilizing the third and fourth switching elements 33, 34 upon performing the boosting operation. FIG. 7 shows a timing chart for the boosting operation utilizing the third and fourth switching elements 33, 34. Graphs G1 to G4 are the same as the graphs of FIG. 4. A graph G5 indicates a gate voltage Vg33 of the third switching element 33, and a graph G6 indicates a gate voltage Vg34 of the fourth switching element 34. Similar to the first and second switching elements 31, 32, a period during which the gate voltage is at a HIGH level corresponds to a period during which the switching element is on, and a period during which the gate voltage is at of a LOW level corresponds to a period during which the switching element is off. The gate voltages Vg33, Vg34 are also controlled by the controller 54.

The controller 54 maintains the third switching element 33 to be on in a period from time T3 to time T4. Each of portions indicated with a reference sign A in FIG. 7 is the period during which the third switching element 33 is maintained to be on. In periods other than the aforementioned, the third switching element 33 is maintained to be off. As described in the first embodiment, the current IL1 flows in the first upper diode 43 in the period from time T3 to time T4. Maintaining the third switching element 33 to be on during this period enables the current IL1 to divide and flow to the first upper diode 43 and the third switching element 33. As a result, the load on the first upper diode 43 can be reduced.

The controller 54 maintains the fourth switching element 34 to be on in a period between time T6 and time T1. Each of portions indicated with a reference sign B in FIG. 7 is the period during which the fourth switching element 34 is maintained to be on. In periods other than the aforementioned, the fourth switching element 34 is maintained to be off. As described in the first embodiment, the current IL2 flows in the second upper diode 44 in the period from time T6 to time T1. Maintaining the fourth switching element 34 to be on during this period enables the current IL2 to divide and flow to the second upper diode 44 and the fourth switching element 34. As a result, the load on the second upper diode 44 can be reduced. In a case where the third and fourth switching elements 33, 34 are maintained to be off at all times during the boosting operation, the operation of the bidirectional converter 10a is the same as that described with reference to FIGS. 4 and 5.

### Third Embodiment

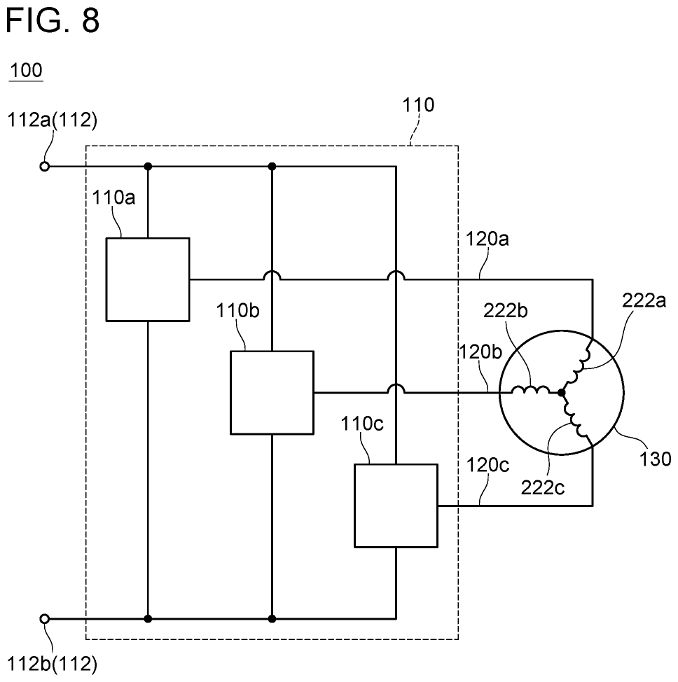

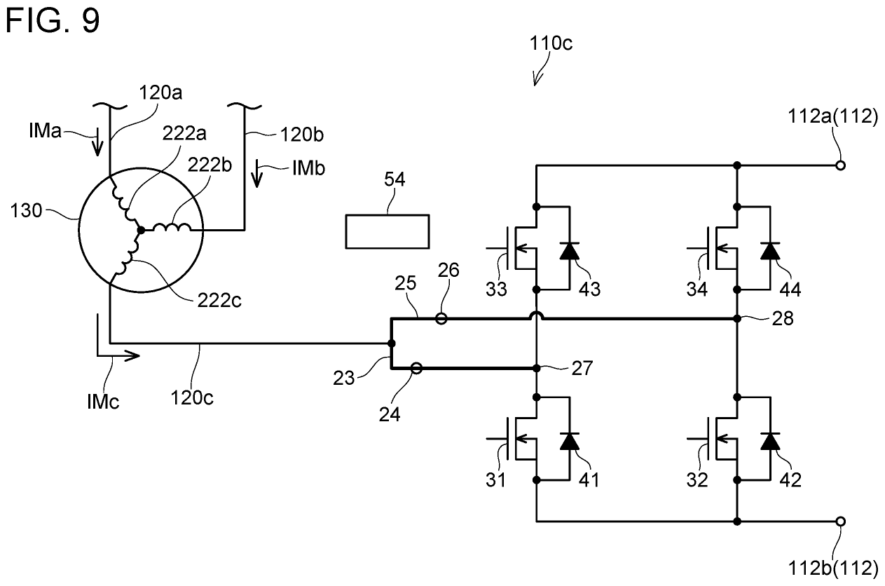

Next, a third embodiment will be described with reference to FIGS. 8 and 9. The third embodiment describes an electric motor system 100 including an inverter 110 and an AC motor 130. The AC motor 130 will hereinbelow be termed the motor 130. DC power is inputted to an input positive terminal 112a and an input negative terminal 112b of an input terminal 112 of the inverter 110. The inverter 110 is configured to convert the inputted DC power to three-phase AC power and supply the AC power to the motor 130.

The inverter 110 includes three switching circuits 110a to 110c. The switching circuits 110a to 110c are connected in parallel between the input positive terminal 112a and the input negative terminal 112b. Each of the switching circuits 110a to 110c converts the DC power to the AC power.

Each of motor wires 120a, 120b, 120c has one end thereof connected to corresponding one of the switching circuits 110a, 110b, 110c. Each of the motor wires 120a, 120b, 120c has another end thereof connected to the motor 130. The motor 130 includes three coils 222a, 222b, 222c. The motor wire 120a is connected to the coil 222a, the motor wire 120b is connected to the coil 222b, and the motor wire 120c is connected to the coil 222c. One ends of the coils 222a to 222c are connected to each other. Such a connection relationship of coils is called a star connection.

Next, the switching circuits 110a, 110b, 110c will be described. Since configurations of the switching circuits 110a, 110b, 110c are the same, the switching circuit 110c will be described hereinbelow.

FIG. 9 shows a circuit diagram of the switching circuit 110c. The configuration of the switching circuit 110c is the same as the configuration of the bidirectional converter 10a according to the second embodiment as shown in FIG. 6. Therefore, hereinbelow, constituent elements of the switching circuit 110c that correspond to constituent elements of the bidirectional converter 10a according to the second embodiment will be given the same reference signs as those used in the second embodiment. The switching circuit 110c includes the switching elements 31 to 34. The first switching element 31 and the second switching element 32 are connected in parallel. The negative terminals of the first and second switching elements 31, 32 are connected to the input negative terminal 112b of the inverter 110. The first lower diode 41 is connected in inverse parallel to the first switching element 31, and the second lower diode 42 is connected in inverse parallel to the second switching element 32.

The anode of the first upper diode 43 is connected to the positive terminal of the first switching element 31, and the anode of the second upper diode 44 is connected to the positive terminal of the second switching element 32. The cathodes of the first and second upper diodes 43, 44 are connected to the input positive terminal 112a of the inverter 110. The third switching element 33 is connected in inverse parallel to the first upper diode 43, and the fourth switching element 34 is connected in inverse parallel to the second upper diode 44.

The intermediate point (the first intermediate point 27) of the series circuit of the first switching element 31 and the first upper diode 43 is connected to the coil 222c of the motor 130. The intermediate point (the second intermediate point 28) of the series circuit of the second switching element 32 and the second upper diode 44 is connected to the coil 222c. The first current sensor 24 is provided on the first conductor 23 that connects the coil 222c and the first intermediate point 27, and the second current sensor 26 is provided on the second conductor 25 that connects the coil 222c and the second intermediate point 28. The first and second current sensors 24, 26 have the same structure as the first current sensor 24 according to the first embodiment. That is, the first current sensor 24 includes the first magnetism collecting ring core 24b through which the first conductor 23 is inserted, and the second current sensor 26 includes the second magnetism collecting ring core 26b through which the second conductor 25 is inserted. The configuration including the first and second current sensors 24, 26, the first and second conductors 23, 25, and the coil 222c according to the third embodiment corresponds to the configuration in which the reactor 22 in FIG. 2 is replaced with the coil 222c.

As is well known, an inverter is provided with three series connections, each constituted of two switching elements. Each switching element on a positive terminal side of the inverter is called an upper-arm switching element, and each switching element on a negative terminal side of the inverter is called a lower-arm switching element. Each of the switching elements has a diode connected in inverse parallel thereto. Each of these diodes is called a freewheel diode.

As is apparent from FIGS. 8 and 9, the first and second switching elements 31, 32 correspond to lower-arm switching elements, and the third and fourth switching elements 33, 34 correspond to upper-arm switching elements. The first and second upper diodes 43, 44 correspond to freewheel diodes connected in inverse parallel to the upper-arm switching elements.

The controller 54 is configured to turn on and off the first switching element 31 and the second switching element 32 alternately and configured to turn on and off the first switching element 31 and the third switching element 33 alternately. The controller 54 is further configured to turn on and off the second switching element 32 and the fourth switching element 34 alternately. In summary, the controller 54 is configured to turn on and off the first switching element 31 and the fourth switching element 34 synchronously and configured to turn on and off the second switching element 32 and the third switching element 33 in the opposite phase to the first switching element 31.

The switching circuits 110a, 110b have the same structure as the switching circuit 110c. The controller 54 drives the three switching circuits 110a to 110c with 120 degrees phase differences. By doing so, the AC power with 120 degrees phase differences (that is, three-phase AC power) is outputted respectively from the three switching circuits 110a to 110c.

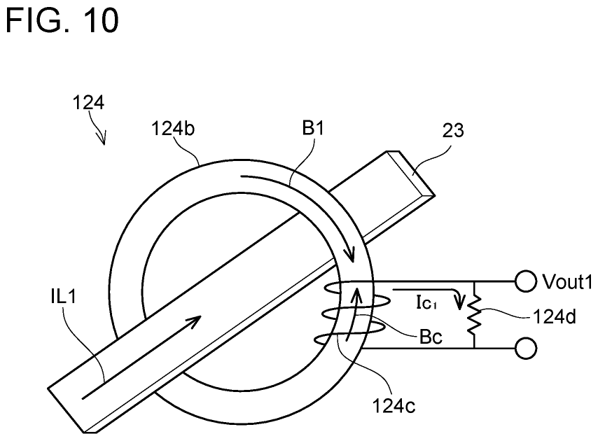

The coils 222a to 222c each have a predetermined reactance similar to the reactor 22 of the first embodiment. The controller 54 is configured to turn on and off the first and second switching elements 31, 32, which are connected in parallel, alternately. Due to this, in the electric motor system 100 provided with the motor 130 and the inverter 110, the magnetism collecting ring cores 24b, 26b of the current sensors 24, 26 function as sub reactors, by which a switching loss is reduced. The electric motor system 100 can suppress the switching loss without any dedicated sub reactors. That is, the electric motor system 100 can reduce the switching loss with a reduced number of components as compared to conventional techniques.

<Variant of Current Sensor> The first and second current sensors 24, 26 provided in the power converter (the boost converter 10) of the first embodiment are of the Hall element type. However, the power converter disclosed herein simply needs to be provided with a magnetism collecting ring core and a current sensor may not be of the Hall element type. FIG. 10 shows a perspective view of a current sensor according to a variant. A current sensor 124 of FIG. 10 is of a coil type. The coil-type current sensor 124 includes a magnetism collecting ring core 124b through which the first conductor 23 is inserted and a coil 124c wound on the magnetism collecting ring core 124b. Magnetic flux B1 is generated in the first magnetism collecting ring core 124b by current IL1 that flows in the first conductor 23. The controller 54 flows current Ic₁ in the coil 124c wound on the first magnetism collecting ring core 124b. This current Ic₁ generates magnetic flux Bc in the magnetism collecting ring core 124b in a direction cancelling the magnetic flux B1 (alternatively, in a direction increasing the magnetic flux B1). A magnitude of the magnetic flux Bc is proportional to a magnitude of the current Ic₁ that flows in the coil 124c. The current IL1 that flows in the first conductor 23 can be measured from current at a time when the magnetic flux of the magnetism collecting ring core 124b becomes zero and a number of turns and a resistance 124d of the coil 124c. The current sensor of FIG. 10 may be used in place of the first current sensor 24 and the second current sensor 26 in the embodiments.

<Cancellation of Errors of Two Current Sensors> Next, errors in current sensors will be described. As described above, the controller 54 obtains the current ILm that flows in the reactor 22 by adding the current IL1 measured by the first current sensor 24 and the current IL2 measured by the second current sensor 26. Each of the current sensors may have an offset error. Hereinbelow, a mechanism that cancels offset errors by adding measured values of two current sensors will be described.

The power converter (the boost converter 10) of the first embodiment uses the first and second current sensors 24, 26 of the Hall element type as shown in FIG. 3. An example of the offset error will be described with the first current sensor 24 of the Hall element type shown in FIG. 3.

The first current sensor 24 detects the current IL1 that flows in the first conductor 23 inserted in the first magnetism collecting ring core 24b. In this case, the voltage Vₒᵤₜ₁ generated in the Hall element 24h is calculated by K×Ib₁×B1+V_{offset}, where B1 is magnetic flux generated in the first magnetism collecting ring core 24b by the current IL1, K is a constant of proportionality, Ib₁ is constant current which the controller 54 flows in the Hall element 24h, and V_{offset} is a voltage that is generated when an input signal to the Hall element 24h is zero. This voltage V_{offset} is an error (offset error) which the Hall element 24h has. A value of the offset error V_{offset} is determined depending on characteristics of a wafer from which the Hall element 24h was cut out, thus a variation in values of the offset error V_{offset} among Hall elements fabricated from a same wafer is very small. As such, in a case where the Hall element 26h of the second current sensor 26 is fabricated from the same wafer as the Hall element 24h, an offset error of the second current sensor 26 is substantially equal to the offset error of the first current sensor 24. The voltage Vₒᵤₜ₂ generated in the Hall element 26h is calculated by K×Ib₁×B2+V_{offset}, where B2 is magnetic flux generated in the second magnetism collecting ring core 26b by the current IL2 flowing in the second conductor 25 and Ib₁ is constant current which the controller 54 flows in the Hall element 26h, which is the same as that in the Hall element 24h. If the voltage Vₒᵤₜ₁ and the voltage Vₒᵤₜ₂ are added as they are, the offset error V_{offset} is doubled, by which the error becomes large.

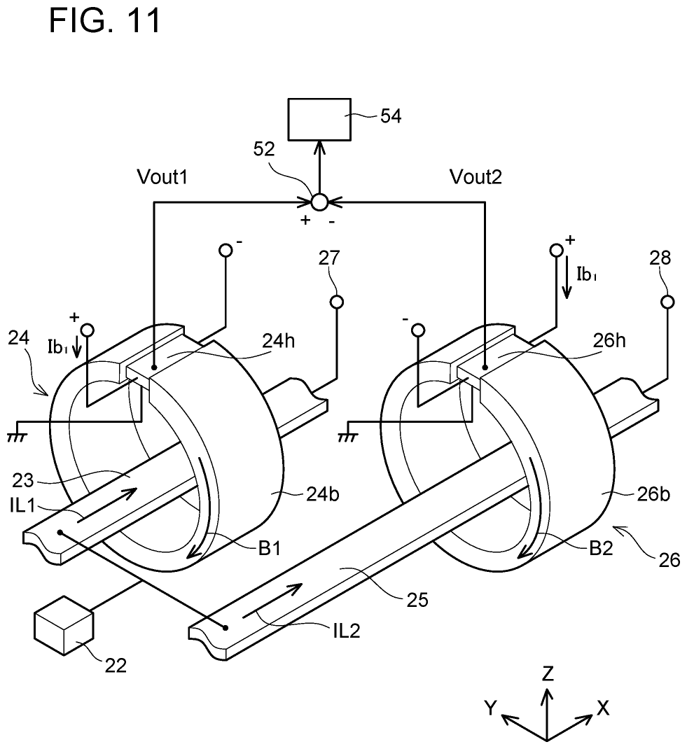

In the boost converter 10 of the first embodiment, the cancellation of the offset errors can be achieved by devising an arrangement of the first and second current sensors 24, 26 and further introducing a difference extractor. An arrangement of the current sensors for cancelling the offset errors is shown in FIG. 11. The first current sensor 24 is arranged to output a positive value when the current flows from the reactor 22 toward the first intermediate point 27, and the second current sensor 26 is arranged to output a negative value when the current flows from the reactor 22 toward the second intermediate point 28. In other words, the first current sensor 24 and the second current sensor 26 are arranged such that their output values have a plus sign and a minus sign that are opposite from each other when currents flow respectively in the first conductor 23 and the second conductor 25 in the same direction. In yet other words, the first current sensor 24 and the second current sensor 26 are arranged such that their outputs have opposite polarity (opposite characteristics) when currents flow respectively in the first conductor 23 and the second conductor 25 in the same direction.

Specifically, as shown in FIG. 11, the first current sensor 24 and the second current sensor 26 are arranged in the same way in terms of geometric. On the other hand, bias currents Ib₁ in opposite directions are flowed respectively in the Hall element 24h of the first current sensor 24 and the Hall element 26h of the second current sensor 26. In the example of FIG. 11, the bias current Ib₁ flows in a +X direction in a coordinate system of the drawing in the Hall element 24h of the first current sensor 24, and the bias current Ib₁ flows in a −X direction in the Hall element 26h of the second current sensor 26. In this case, when currents in the same direction (currents that flow from the reactor 22 toward the intermediate points) flow in the first conductor 23 and the second conductor 25, the output of one of the current sensors (e.g., the first current sensor 24) is a positive value and the output of the other of the current sensors (e.g., the second current sensor 26) is a negative value.

According to the above, the voltage Vₒᵤₜ₁ generated in the Hall element 24h is Vₒᵤₜ₁=K×Ib₁×B1+V_{offset}, where B1 is magnetic flux that is generated in the first magnetism collecting ring core 24b when the current IL1 flows from the reactor 22 toward the first intermediate point 27. Further, the voltage Vₒᵤₜ₂ generated in the Hall element 26h is Vₒᵤₜ₂=−K×Ib₁×B2+V_{offset}, where B2 is magnetic flux that is generated in the second magnetism collecting ring core 26b when the current IL2 flows from the reactor 22 toward the second intermediate point 28. The signs of the Vₒᵤₜ₁ and Vₒᵤₜ₂ are opposite because the directions of the bias currents Ib₁ are opposite in the first current sensor 24 and the second current sensor 26. In this case, the current that flows in the reactor 22 can be obtained by a difference between the output Vₒᵤₜ₁ of the first current sensor 24 and the output Vₒᵤₜ₂ of the second current sensor 26. In the example of FIG. 11, the difference between Vₒᵤₜ₁ and Vₒᵤₜ₂ is obtained by a difference extractor 52, and a result thereof is inputted to the controller 54. By obtaining the difference between Vₒᵤₜ₁ and Vₒᵤₜ₂, the offset errors V_{offset} of the two current sensors 24, 26 can be cancelled. The current that flows in the reactor 22 can be measured with high accuracy by applying the component arrangement and the different extractor 52 shown in FIG. 11 to the power converters of the embodiments (such as the boost converter 10 and the bidirectional converter 10a).

Sensors generally have offset errors. Therefore, offset errors of current sensors can be reduced by arranging two current sensors to have opposite characteristics and introducing a difference extractor, even when the current sensors are of another type other than the Hall element type.

What is claimed is:

1. A power converter comprising:
a first switching element;
a second switching element connected in parallel to the first switching element;
a first diode connected to a positive terminal of the first switching element;
a second diode connected to a positive terminal of the second switching element;
a reactor including one end connected to a first intermediate point and a second intermediate point, the first intermediate point being an intermediate point in a series circuit of the first switching element and the first diode, and the second intermediate point being an intermediate point in a series circuit of the second switching element and the second diode;
a first current sensor configured to detect current flowing between the reactor and the first intermediate point;
a second current sensor configured to detect current flowing between the reactor and the second intermediate point; and
a controller configured to alternately turn on the first switching element and the second switching element,
wherein
the first current sensor comprises a first magnetism collecting ring core into which a first conductor between the reactor and the first intermediate point is inserted, and
the second current sensor comprises a second magnetism collecting ring core into which a second conductor between the reactor and the second intermediate point is inserted.

2. The power converter of claim 1, wherein
the first current sensor is arranged so as to output a positive value when current flows from the reactor to the first intermediate point,
the second current sensor is arranged so as to output a negative value when current flows from the reactor to the second intermediate point, and
the power converter further comprises a difference extractor configured to acquire a difference between an output from the first current sensor and an output from the second current sensor.

3. An electric motor system comprising the power converter of claim 1, wherein
the first switching element and the second switching element are provided as lower-arm switching elements of an inverter,
the first diode and the second diode are provided as freewheel diodes of upper-arm switching elements of the inverter, and
the reactor is a winding wire of an electric motor.

4. An electric motor system comprising the power converter of claim 2, wherein
the first switching element and the second switching element are provided as lower-arm switching elements of an inverter,
the first diode and the second diode are provided as freewheel diodes of upper-arm switching elements of the inverter, and
the reactor is a winding wire of an electric motor.
